(19) United States
(12) Patent Application Publication
(10) Pub. No.: US 2018/0370199 A1
(43) Pub. Date: Dec. 27, 2018

(54) Laminated Films

(71) Applicant: Jindal Films Americas LLC, LaGrange, GA (US)

(72) Inventors: Thierry J. L. Dabadie, Luxembourg (LU); Benoît Ambroise, Nobressart (BE)

(73) Assignee: Jindal Films Americas LLC, LaGrange, GA (US)

(21) Appl. No.: 15/573,915

(22) PCT Filed: May 23, 2016
(86) PCT No.: PCT/US16/33801

§ 371 Date: Nov. 14, 2017

Related U.S. Application Data
(60) Provisional application No. 62/165,050, filed on May 21, 2015.

(51) Int. Cl. B32B 27/08; B32B 27/32; B32B 27/40; B32B 27/36; B32B 37/04

(52) U.S. Cl. CPC B32B 27/08; B32B 2439/06; B32B 27/40; B32B 27/36; B32B 37/04; B32B 2255/10; B32B 2255/20; B32B 2255/205; B32B 2255/26; B32B 2307/31; B32B 2307/4023; B32B 2307/514; B32B 2307/718; B32B 2307/75; B32B 2439/70; B32B 2439/46; B32B 27/32

(57) ABSTRACT

Disclosed are methods, compositions and structures for laminated films. In one example embodiment, disclosed is a structure and composition, which includes a printable coating receptive to electrophotographic ink, an optionally oriented film having a coating side and a laminating side, wherein the printable coating is applied to the coating side, and a substrate dry-laminated to the laminating side.

### REFERENCE TO RELATED APPLICATION

The present application is a Patent Cooperation Treaty (PCT) application, which claims priority to the U.S. provisional patent application Ser. No. 62/165,050 filed May 21, 2015, which is hereby incorporated by reference in its entirety.

### FIELD

The disclosure relates to non-adhesive lamination of coated, polymeric films.

### BACKGROUND

This disclosure generally relates to methods, compositions, and structures, such as packages, bags, tags, labels, horizontal-form-fill-and-seal (“HFFS”) containers, vertical-form-fill-and-seal (“VFFS”) containers, lids, sachets, stand-up pouches, overwraps, and so forth (i.e., collectively “applications”) associated with coated films for optional use on printing presses, e.g., HP® Indigo 20000 Digital Press.

### SUMMARY

In one example embodiment, disclosed is a structure and composition, which includes a printable coating receptive to electrophotographic ink, an optionally oriented film having a coating side and a laminating side, wherein the printable coating is applied to the coating side, and a substrate dry-laminated to the laminating side.

In another example embodiment, disclosed is use of the preceding paragraph's structure and composition for wrapping, containing or identifying food or non-food items, i.e., multilayered film applications intended for use in producing, manufacturing, packing, processing, preparing, treating, packaging, transporting, labeling, taping, or holding food or non-food items.

In another example embodiment, disclosed is a method for making a laminated film. The method may include co-extruding a first coated film with a second coated film, wherein the first coated film comprises electrophotographic ink printed onto a print-receptive coating. Furthermore, the method may include laminating, subsequent to the co-extruding, so that the electrophotographic ink is encapsulated between the first coated film and the second coated film.

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 is a table of coating compositions for a printable surface on a film, which may be sealed/laminated to a substrate, e.g., another film, in accordance with the disclosed methods, devices, and compositions.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

The term “comprising” and its derivatives are not intended to exclude the presence of any additional component, step or procedure, whether or not the same is specifically disclosed. In order to avoid any doubt, any process or composition claimed through use of the term “comprising” may include any additional steps, equipment, additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or,” unless stated otherwise, refers to the listed members individually as well as in any combination.

Unless stated to the contrary, implicit from the context, or customary in the art, all parts and percentages are based on weight and all test methods are current as of the filing date of this disclosure. The contents of any referenced patent, patent application or publication are incorporated by reference in its entirety, especially with respect to the disclosure of synthetic techniques, definitions (to the extent not inconsistent with any definitions specifically provided in this disclosure), and general knowledge in the art.

As used herein, “polymer” means a compound prepared by polymerizing monomers, whether of the same or a different type. The term “polymer” as used herein generally includes, but is not limited to, homopolymers, copolymers, interpolymers, terpolymers, etc., such as, for example, block, graft, random and alternating copolymers, terpolymers, etc. and blends and modifications thereof. As used herein, unless specified otherwise, the term “copolymer(s)” refers to polymers formed by the polymerization of at least two different monomers. For example, the term “copolymer” includes the copolymerization reaction product of propylene and an α-olefin, such as ethylene. However, the term “copolymer” is also inclusive of, for example, the copolymerization of a mixture of more than two monomers, such as, ethylene-propylene-butene.

This disclosure generally relates to methods, compositions, and structures, such as packages, bags, tags, labels, horizontal-form-fill-and-seal (“HFFS”) containers, vertical-form-fill-and-seal (“VFFS”) containers, lids, sachets, stand-up pouches, overwraps, and so forth (i.e., collectively “applications”) associated with coated films for optional use on printing presses, e.g., HP® Indigo 20000 Digital Press. In the example disclosed herein, a first multilayered film includes a printed ink (e.g., HP® Indigo printable inks), which is an ink printed on a material surface coating, which may be activated by heat and/or pressure. The inks used may be in resinous and polymeric coatings intended as the food or non-food contact surface of multilayered film applications intended for use in producing, manufacturing, packing, processing, preparing, treating, packaging, transporting, labeling, taping, or holding food or non-food items, i.e., “applications for wrapping, containing or identifying food or non-food items.” These coatings may be continuous coatings, and, in many cases, may be cross-linked. The first multilayered film may be laminated through heat, pressure, or combinations thereof to a second multilayered film, either or both of which, for instance, may be optionally oriented film(s) having a polypropylene-base, polyethylene-base, polyester-base, polymer-base, or combinations thereof. Combination of the first and second multilayered films may exude outstanding, dry (i.e., without any permanent adhesive) thermal lamination sealability, i.e., heat-seal/lamination and/or pressure-seal/lamination performance in terms of bond strength, printability, flexibility, packagability, and machinability characteristics. These characteristics may result in use of such laminates in applications for the food or non-food industry in optional combination with use of a printing process.

Returning to the foregoing discussion of inks, the films may by digitally printed through the use of electrophotographic inks, such as those that are acceptable for use in the food packaging industry. Digital printing on film substrates is becoming more common due to the film substrates' flexibility, which allows for printing of variable images directly from a computer to a film substrate.

Electrophotographic inks may be liquid or dry toners that are electrostatically charged to form an image, which is transferred and melted to a substrate. Electrophotographic inks may be used to digitally print a film substrate, which requires lamination in order to protect the ink's surface for final use, e.g., packaging food or non-food product(s), so as to prevent the product(s) from being in direct contact with the toner or the solvent, which may not be approved for direct contact with products, especially when the products are food.

Unfortunately, adhesives used to laminate a protective film to an electrophotographically printed film are not functional for food packaging due to low adhesive bonds.

Instead of adhesives, thermal and/or pressure lamination is used herein to laminate a film to protect paper-based substrates, such as printed graphics on paper, book covers, prospectuses, etc., as described, for instance, in U.S. Pat. No. 6,153,298. The film to be dry-laminated by heat and/or pressure may, for instance, have a very thick layer (e.g., ˜15 am) of a heat-laminated film resin based on ethyl vinyl alcohol (“EVA”) or ethylene acrylic acid (“EAA”), and may be used to thermally bond to digitally printed desktop paper substrates.

Biaxially oriented polypropylene (“BOPP”) films may be used for food or non-food packaging, and may have a coating to be compatible with digital printing methods, such as those using electrophotography toners. BOPP films coated with the same coating may be thermally laminated to digitally printed films containing electrophotographic inks.

It was surprisingly found that the same coating may be functional for both electrophotography printing and thermal lamination, despite being based on different principles. Electrophotography printing may include a liquid toner, and is based on swelling of the coating polymer by the solvent, which is used in the liquid toner. Heat in the digital printing process is used to adjust the viscosity of the liquid toner and evaporate the solvent. In thermo-lamination, however, lamination occurs by using heat to fuse the polymer above its fusion temperature.

Electrophotography printing is a digital printing method that may be used on plastic and paper substrates, and is based on a liquid or solid toner, which is charged electrostatically to form an image, which is transferred and heat-fused to the substrates. Hewlett-Packard Company developed this printing method based on liquid toner (i.e., Indigo, as described in US 2005/0221209). Xerox and Xeikon developed printing this method based on a solid toner. Liquid toner-chemistry may be found in U.S. Pat. No. 7,078,141, and may be based on polymers of ethylene-co-methacrylic acid (“EMAA”) and EAA, ionomers, and the same polymers and EVA with maleic-anhydride functionalities. Solid toner-chemistry may be found in EP 0 913 735 granted to Xeikon. Solid toner-chemistry is based on pigments in polyester polymers or styrene-acrylic polymers. Plastic substrates often need to be coated to be compatible with electrophotographic inks. An EAA-based dispersion used as a heat-sealable coating on BOPP film has been found to be printable by liquid toners as described in U.S. Pat. No. 5,789,123 issued to Mobil. Other coatings are disclosed in EP 0 913 735 granted to Michelman, and are based on blends of EAA and polyurethane.

BOPP films that undergo heat lamination may have very thick layers (e.g., ˜10-15 am) of heat-sealable polymers like EAA, EVA or ionomers such as those described in U.S. Pat. No. 5,126,197 issued to Wolff and U.S. Pat. No. 6,153,298 issued to General Binding Corp. The thick, heat-activated layer is applied during the BOPP process (e.g., extrusion-coated between the MDO and TDO to avoid sticking on the MDO rolls) or off-line extrusion-coated on a primed BOPP film. Those films are specifically designed to laminate to paper-based substrates, are expensive to produce, and may not easily conform into flexible packaging applications due to the stickiness of the heat-laminated layer.

Accordingly, this disclosure describes thin coating layers for use in methods, and on structures and compositions that may use electrophotographically printed inks on thermally printable films.

To familiarize with terminology used herein, a multilayered film may have an A/B/C structure comprising at least a “core layer” “C”, an optional “tie layer(s)” “B” and a “skin layer” “A” with the tie layer between the core and sealant layers. Functionally, the layers impart protection/cavities/color and can desirably be co-extruded layers of polymer or polymer mixtures. The multilayered films may include processing aids or one or more additives such as opacifying agent, coloring agents, inks, pigments cavitating agents, slip agents, anti-static agents, anti-block agents, and combinations thereof, so as to produce a translucent or opaque film, as desired.

As used herein, “polymer” may be used to refer to homopolymers, copolymers, interpolymers, terpolymers, etc.

The multilayered films may or may not be uniaxially or biaxially oriented. Orientation in the direction of extrusion is known as machine direction (“MD”) orientation. Orientation perpendicular to the direction of extrusion is known as transverse direction (“TD”) orientation. Orientation may be accomplished by stretching or pulling a film first in the MD followed by the TD. Orientation may be sequential or simultaneous, depending upon the desired film features. Orientation ratios are commonly from between about three to about six times the extruded width in the MD and between about four to about ten times the extruded width in the TD.

Blown films may be oriented by controlling parameters such as take up and blow up ratio. Cast films may be oriented in the MD direction by take up speed, and in the TD through use of tenter equipment. Blown films or cast films may also be oriented by tenter-frame orientation subsequent to the film extrusion process, in one or both directions. Typical commercial orientation processes are biaxially oriented polypropylene (“BOPP”) tenter process and Linear Motor Simultaneous Stretching (“LISIM”) technology.

One or both of the outer exposed surfaces of the multilayered films may be surface-treated to increase the surface energy of the film to render the film receptive to metallization, coatings, printing inks, and/or lamination. The surface treatment may be carried out according to one of the methods known in the art. Exemplary treatments include, but are not limited to, corona-discharge, flame, plasma, chemical, by means of a polarized flame, or otherwise.

One or both of the outer exterior surfaces of the multilayered films may be metallized. Generally, when films are metallized, the metallized layer is one of the outer skin and/or sealant layers. However, if no skin or sealant layer is present, the surface of a core layer may be metallized. Such layers may be metallized using conventional methods, such as vacuum deposition, of a metal layer such as aluminum, copper, silver, chromium, or mixtures thereof from an oxide or otherwise of such metals.

In some embodiments, the film may first be surface treated, for example, by flame treatment, and then be treated again in the metallization chamber, for example, by plasma treatment, immediately prior to being metallized.

Further disclosure of the first multilayered film now ensues. The core layer of the first multilayered film may include one or more polymers, such as and without limitation, polypropylene-based polymers (“PP”) or co-polymers thereof, polyester-based polymers (“PET”) (e.g., polyethylene-naphthalate-based polymers (“PEN”), polylactide-based polymers (“PLA”), etc.), polyethylene-based polymers (“PE”) or co-polymers thereof, polyamide-based polymers (“PA”), other polymers, and combinations of the foregoing. The first multilayered film may be prepared by any suitable means, including co-extrusion, casting, orienting, and then prepared for its intended use such as by coating, printing, slitting, or other converting methods. The core layer may further include elastomers, plastomers, ethylene-vinyl-alcohol (“EVOH”)-based polymers, and combinations thereof. The core layer may also include additives as previously defined.

In one example embodiment, the core layer film includes a BOPP, such as an ethylene-propylene (“EP”) copolymer, an ethylene-propylene-butene (“EPB”) terpolymer, a PP homopolymer, and combinations thereof, with or without the addition of one or more plastomers, elastomers, or EVOH-based polymers, and combinations thereof. Such polymer(s) may or may not vary in density, stereoregularity, and method of production, e.g., metallocene-catalyzed, Zeigler-Natta-catalyzed, enzyme-catalyzed, non-catalyzed, etc. Examples of suitable elastomers/plastomers include, without limitation, ExxonMobil®'s Vistamaxx®'s, e.g., VMX 6102, Dow®'s Versify®'s, and many others. In yet another example embodiment, the core layer includes a biaxially oriented polyester, such as polyester terephthalate (“PET”) or a biaxially oriented polyamide (“PA”).

The opposite side of the side that may be thermally laminated may also include a coating layer for added functionality, printing and/or otherwise. Examples of coating for the opposite side include acrylic coatings to provide good machinability of the laminate on packaging machines and provide aroma protection, polyvinyl dichloride (“PVdC”), which may provide sealability and oxygen barrier protection polyvinyl alcohol (“PVOH”), which may provide oxygen barrier protection, other polymers, and combinations thereof. In additional or alternative example embodiments, the multilayered film, itself, may be a coated film, and, thereby, produce a multilayered film having more than one coated layer. Take, for example, application of an EVOH coating to a first multilayered film to effect barrier properties. This multilayered film would have ultra-high barrier properties and the advantage of sealant technology, all the while avoiding the complexity of coextruding an EVOH layer with polypropylene on an orienter.

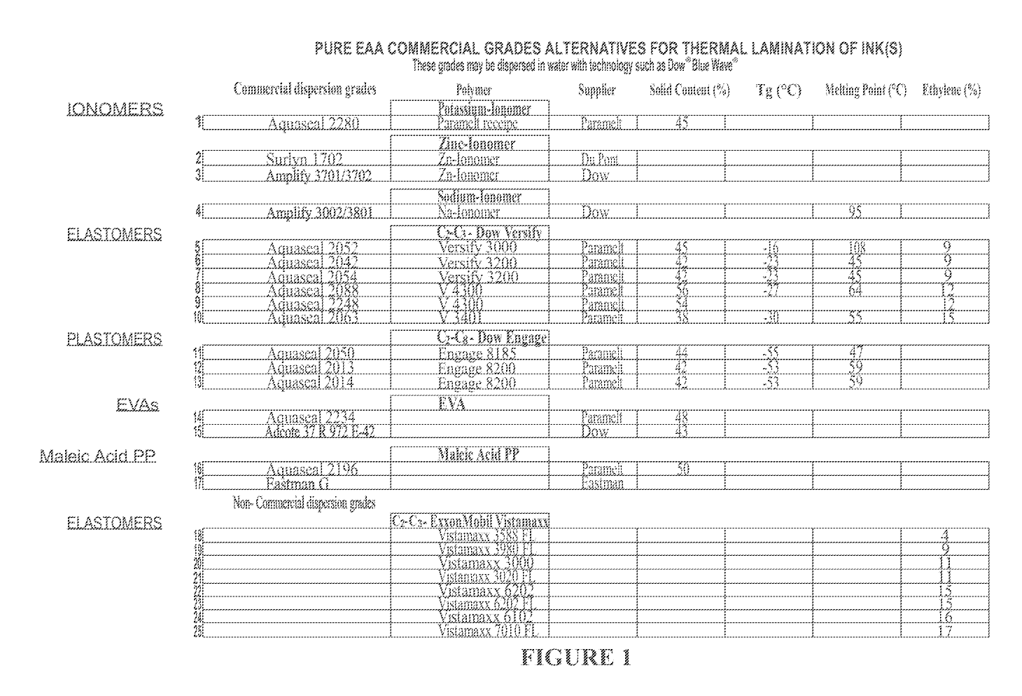

The first multilayered film may be coated so as to form an A/B multilayered film structure. Such coating may be ethylene acrylic acid, but its chemical nature may be broadened by alternatives, such as by those example polymers (e.g., ionomers, elastomers, ethylene vinyl acetate, etc.) shown in FIG. 1. The coating layer may provide a printable surface, such as with a HP® Indigo 20000 Digital Press, wherein such printable, first multilayered film may be sealed/laminated to a second multilayered film, which may have the same or different coatings, primers, sealings, metallizings, and/or other additives added thereto as compared to the first multilayered film.

Prior to application of the coating(s) to the first multilayered film, a primer may be applied in order to enhance, for instance, wetting and/or adhering to the first multilayered film's coating layer, which may also function as a sealing layer. Example embodiments may have the primer including one or more polymers, such as and without limitation, polyethylenimine-based polymers (“PEI”), polyurethane-based polymers (“PU”), polymers such as elastomers and/or plastomers, and combinations thereof. In various examples, the coating weight of the primer may be within the range of 0.05 to 0.5 g/m². Also in alternative, example embodiments, the coating layer may include a polyolefin dispersion (“POD”) that is coated onto the core layer of the first multilayered film. The POD may have a high solids' content, for example, greater than 25% by weight. The POD may be prepared using BLUEWAVE™ technology and processes developed by Dow®. The POD may include one or more ionomers, such as Surlyn®, Amplify®, polymers, such as elastomers, plastomers, and combinations thereof, EVA-based polymers, vinyl-alcohol-based (“VOH”) polymers, EAA-based polymers, PP-based polymers, PE-based polymers, organic acids, such as maleic-acid-based (“MA”), and combinations of the foregoing. In alternative embodiments, the coating layer may be based on polyurethane-based polymers (“PU”). The coating layer may further include additives, such as those previously listed in this disclosure. In various examples, the coating layer's weight may be within the range of 0.5 to 20.0 g/m².

As previously mentioned, in further example embodiments, the disclosed methods, compositions, and structures may include layers in addition to the foregoing layers that are located opposite to the side that may be thermally laminated. An example of such may include one or more coating layers directly or indirectly of the core layer of the first multilayered films. In this sense, the multilayered film is directly or indirectly flanked by coating layers having optional sealing functionality, wherein, as previously disclosed, the second side of the core layer may be primed prior to application of any coating layers. Sealable coating layers may include one or more polymers, such as and without limitation, EAA-based polymers, acrylic-based polymers, one or more ionomers, such as Surlyn®, Amplify®, polymers, such as elastomers, plastomers, and combinations thereof, EVA-based polymers, vinyl-alcohol-based (“VOH”) polymers, EAA-based polymers, PP-based polymers, PE-based polymers, organic acids, such as maleic-acid-based (“MA”), PVDC, such as Daran® 8300, and combinations of the foregoing; further, such one or more polymers for any coatings, sealable or not, may be matte, glossy, hazy, translucent, opaque, or otherwise. In various examples, the coating weight of the printable coating layers, which may be printable, may be within the range of 0.5 to 15.0 g/m². Whether primed or not on a first side, second side, or both prior to applying one or more coatings on to either or both sides of the core layer of the first multilayered film, optional lamination to second multilayered films may occur as later disclosed herein.

In optional and still further example embodiments, the first multilayered film may be metallized, as previously discussed, instead of or in addition to the foregoing layers. For such metallization, metal oxide layer(s) may be deposited intermediate to the core layer and/or to the optionally primed/sealed coating layers. In alternative embodiments, the metal oxide layer(s) may be coated with coating processes, such as direct or reverse gravure, flexography or offset. As previously discussed, any of first multilayered film's layers may be treated prior to metallizing.

Further disclosed is a second multilayered film, which, like the first, may be prepared by any suitable means, including co-extrusion, casting, orienting, and then prepared for its intended use such as by coating, printing, slitting, or other converting methods. The core layer may include BOPP-based polymers, PE/BOPE-based polymers, BOPET-based polymers, other polymers, and combinations thereof. Additionally and alternatively, the core layer may be oriented mono-axially in the machine or transverse direction; in the alternative, the core layer may be oriented bi-axially (“BO”).

In example embodiments, the second multilayered film's core layer may include one or more BOPPs, such as EP copolymers, EPB terpolymers, PP homopolymers, other polymers, and combinations thereof, with or without the addition of one or more plastomers, elastomers, EVOH-based polymers, other polymers, and combinations thereof. Examples of suitable elastomers/plastomers include, without limitation, ExxonMobil®'s Vistamaxx®'s (e.g., 6102 and so forth), Dow®'s Versify®'s, and so forth. In yet other example embodiments, the core layer includes one or more BOPETs, such as polyester terephthalate (“PET”) or a biaxially oriented polyamide (“PA”). Additionally and alternatively, the core layer may further include additives, such as those previously disclosed.

As with the first multilayered film, the second multilayered film's core layer may have one or more coating layers that optionally impart sealability, and such coating layers may be primed, treated, and/or metallized as previously discussed. Such coating layers may exist on the first and/or second side(s) of the second multilayered film's core layer.

In various embodiments, the disclosed methods, systems, and structures may provide for two coated, flexible BOPP, PE/BOPE, BOPET, BOPA, or other multilayered films having core layers of PP, PET, PA or otherwise. Furthermore, such films may have sealing layers having at least one primer layer of a water-based ethylene-imide or urethane polymer; any of the foregoing may also optionally include elastomer(s) and/or plastomer(s), and at least one sealing layer comprising an ethylene acrylic acid, ionomer (e.g., potassium, sodium, or zinc), elastomer, plastomer, EVA, MAPP and/or blends thereof, such as those reported in FIG. 1.

Yet further, such disclosed films optionally may include at least one sealable, water-based (or other solvent) coating at least temporarily adhered opposite of the sealing/lamination layer, wherein the sealing coating may include at least one primer layer of a water-based (or other solvent) ethylene-imide, EAA, urethane, or other polymer, and at least one sealing layer comprising EAA-based polymers, acrylic-based polymers, one or more ionomers, such as Surlyn®, Amplify®, polymers, such as elastomers, plastomers, and combinations thereof, EVA-based polymers, vinyl-alcohol-based (“VOH”) polymers, EAA-based polymers, PP-based polymers, PE-based polymers, organic acids, such as maleic-acid-based (“MA”), PVDC, such as Daran® 8300, and blends thereof.

The coating weight of ethylene-imide or urethane polymer primer may be from 0.050 g/m² to 0.50 g/m² or otherwise.

The disclosed films may have very low temperature sealing coating(s) (“VLTSC”) on the sealing layers. For instance, sealing activating temperatures for achieving 300 g/inch seal strengths are in the range of 80° C. to 90° C. In order to improve fitness-for-use, VLTSC's may be formulated with wax and/or particles. The level of wax and solid particles may be adjusted so that the kinetic and static coefficients of friction (“COFs”) on metal are less than 0.80 or 0.60 or 0.50 or 0.40 or 0.30.

As revealed at the outset, various applications are possible to construct from the compositions and methods disclosed herein. Worthy of repeat, however, such applications may be packages, bags, tags, labels, horizontal-form-fill-and-seal (“HFFS”) containers, vertical-form-fill-and-seal (“VFFS”) containers, lids, sachets, stand-up pouches, overwraps, over-laminations, for example, of labels, bags, or any of the foregoing, and various other applications.

Exemplary methods for unwinding the disclosed films may include in a VFFS or HFFS (i.e., “pouches”) machine and fed therethrough in order to form bags, which may or may not ultimately contain food or non-food item(s), wherein an optional metallized side of the disclosed film faces or faces away from the item(s) contained or to-be-contained therein.

Below are experimental results for co-extrusion of Film #1 and Film #2 in each of the Examples #1-#3 to form a laminated, multilayered film. Stated otherwise, Film #1 and Film #2 are co-extruded and coated. By laminated film, what is meant in this example, at least, is that the HP® Indigo ink particles printed on Film #1 are encapsulated between Film #1 and Film #2 in order to avoid indirect or direct contact, for example, with food or non-food items to be packaged.

The examples below are BOPP films, which were coated with EAA-based dispersions as described in U.S. Pat. No. 5,789,123. These coated, BOPP films were then printed on a Hewlett-Packard Indigo printer using liquid toner ink. Each Indigo-printed, coated, BOPP film was heat-sealed to a film to simulate thermal lamination. The thermal laminate assembly was tested in accordance with standard test methods to determine bond strength.

### Example #1

Film#1: HP® Indigo CMYK (i.e., cyan, magenta, yellow, band black inks) printed on top of an EAA-based dispersion coated BOPP film
Film#2: EAA-coated BOPP
Dwell time: 0.2 s
Pressure: 25 N/cm² or 250 kPa—crimp jaws

| | Temperature (° C.) | | | | | |
|---|---|---|---|---|---|---|
| | 100 | 110 | 120 | 130 | 140 | 150 |
| Bond Strength | 95 | 105 | 165 | 220 | 180 | 290 |
| (g/inch) | | | | | | |

### Example #2

Film#1: HP® Indigo CMYK (i.e., cyan, magenta, yellow, band black inks) printed on top of an EAA based dispersion coated BOPP film
Film#2: ionomer-coated BOPP
Dwell time: 0.2 s
Pressure: 25 N/cm² or 250 kPa—crimp jaws

| | Temperature (° C.) | | | | | |
|---|---|---|---|---|---|---|
| | 100 | 110 | 120 | 130 | 140 | 150 |
| Bond Strength | 115 | 145 | 190 | 205 | 240 | 380 |
| (g/inch) | | | | | | |

### Example #3

Film#1: HP® Indigo CMYK (i.e., cyan, magenta, yellow, band black inks) printed on top of an EAA-based dispersion coated BOPP film
Film#2: elastomer-coated BOPET
Dwell time: 0.2 s
Pressure: 25 N/cm² or 250 kPa—crimp jaws

| | Temperature (° C.) | | | | | |
|---|---|---|---|---|---|---|
| | 100 | 110 | 120 | 130 | 140 | 150 |
| Bond Strength | 185 | 225 | 230 | 265 | 355 | 200 |
| (g/inch) | | | | | | |

In view of the foregoing, various bags and films may be formed from the above-described, coated, flexible, multilayered films. For example, in one embodiment, a food bag is formed from twice-coated, flexible multilayered film, wherein an optional metallized side of the multilayered film faces away from the food contained therein. In another embodiment, a food bag is formed from a coated flexible film, wherein an optional metallized side of the multilayered film is in contact with (i.e., faces towards) the food contained therein. And, in yet another embodiment, food packaging is formed that may include a sealed bag/pouch made through use of machine-packaging equipment, such as HFFS, VFFS, and/or other pouch packaging machines.

While the foregoing is directed to example embodiments of the disclosed invention, other and further embodiments may be devised without departing from the basic scope thereof, wherein the scope of the disclosed applications, compositions, structures, labels, and so forth are determined by one or more claims of at least one subsequently filed, non-provisional patent application.

What is claimed is:

1. A composition comprising:
a printable coating receptive to electrophotographic ink;
an optionally oriented film having a coating side and a laminating side, wherein the printable coating is applied to the coating side; and
a substrate dry-laminated to the laminating side.

2. The composition of claim 1, wherein the optionally oriented film comprises a coated film.

3. The composition of claim 1, further comprising primer(s) on the coating side, the laminating side, or both.

4. The composition of claim 1, further comprising one or more coatings comprising a sealant, barrier coating, machinability coating, the printable coating, another printable coating, and combinations thereof, wherein the one or more coatings are applied to the laminating side.

5. The composition of claim 4, wherein the one or more coatings comprise a polyolefin dispersion or a polyurethane-based polymer.

6. The composition of claim 4, wherein the printable coating has a coating weight in a range from 0.5 to 15 g/m².

7. The composition of claim 1, further comprising a primer and a sealable coating on the coating side.

8. The composition of claim 1, wherein lamination of the substrate dry-laminated to the laminating side has sealing activating temperatures in a range from 80° C. to 90° C. for 300 g/inch seal strengths.

9. The composition of claim 1, further comprising a seal strength of 200 g/inch or more at a pressure of 250 kPa for a 0.2 s dwell time at 150° C.

10. The composition of claim 1, wherein the optionally oriented film is treated.

11. The composition of claim 1, further comprising additives in the optionally oriented film, substrate, or both.

12. The composition of claim 1, wherein a metal, metal oxide, or combinations thereof is deposited on the optionally oriented film, substrate, or both.

13. The composition of claim 1, wherein the optionally oriented film, the substrate or both comprise one or more polymeric films, one or more polyester films, or combinations thereof.

14. The composition of claim 1, wherein the coating is safe for food-contact applications.

15. The composition of claim 1, wherein the coating is cross-linked.

16. A method comprising:
co-extruding a first coated film with a second coated film, wherein the first coated film comprises electrophotographic ink printed onto a print-receptive coating; and
laminating, subsequent to the co-extruding, so that the electrophotographic ink is encapsulated between the first coated film and the second coated film.

17. Use of the composition of claim 1 in applications for wrapping, containing or identifying food or non-food items.
